(19) United States
(12) Patent Application Publication
(10) Pub. No.: US 2025/0298573 A1
(43) Pub. Date: Sep. 25, 2025

(54) TERMINAL CONTROL METHOD, ELECTRONIC DEVICE, AND STORAGE MEDIUM

(71) Applicant: SHENZHEN ZOLON TECHNOLOGY CO., LTD., Shenzhen (CN)

(72) Inventors: YOUREN CHEN, Shenzhen (CN); LINGCONG ZENG, Shenzhen (CN); HUAN WANG, Shenzhen (CN)

(21) Appl. No.: 18/860,218

(22) PCT Filed: Mar. 21, 2023
(86) PCT No.: PCT/CN2023/082881

§ 371 Date: Oct. 25, 2024

(30) Foreign Application Priority Data
May 12, 2022 (CN) 202210515920.1

(51) Int. Cl. G06F 3/147; H04M 1/72436; H04M 1/72445

(52) U.S. Cl. CPC G06F 3/147; H04M 1/72436; H04M 1/72445; H04M 2201/42

(57) ABSTRACT

A terminal control method, an electronic device, and a storage medium are provided. The method includes: in response to receive a control request from a second terminal, and the first terminal has at least one physical navigation button, obtaining a two-dimensional menu according to the physical navigation button; obtaining a stitched image according to the two-dimensional menu and a screen image of the first terminal; and receiving operation data of the second terminal according to the stitched image, generating and responding to an instruction corresponding to the operation data.

This application claims priority of Chinese Patent Application No. 202210515920.1, entitled “a terminal control method and device, an electronic device, and a storage medium”, filed on May 12, 2022 in the China National Intellectual Property Administration (CNIPA), the entire contents of which are incorporated by reference herein.

### TECHNICAL FIELD

The present disclosure herein generally relates to a technical field of control, and particularly to a terminal control method, a terminal control device, an electronic device, and a storage medium.

### BACKGROUND

Screen synchronization between a remote POS terminal and a tablet can be achieved through a TCP/IP (Transmission Control Protocol/Internet Protocol) network. Problem of the POS terminal being controlled by the tablet is that only simple operations can be performed on the tablet, and only the content of the screen of the POS terminal can be operated in the synchronization screen, while the physical navigation buttons cannot be operated, which causes large limitations on the application of POS terminal control, for example, when the POS terminal is required to be shut down remotely, the shutdown button cannot be activated, and the POS terminal cannot be controlled to be shut down.

### BRIEF DESCRIPTION OF THE DRAWINGS

In order to more clearly state the technical solution in the embodiment of the present disclosure or the prior art, the following is a brief introduction of the drawings required to be used in the description of the embodiment or the prior art, it is obvious that the drawings described below are only some embodiments of the present disclosure, for those skilled in the art, other drawings can also be obtained from these drawings without creative efforts.

FIG. 1 is a schematic view of an embodiment of an exemplary system architecture according to the present disclosure;

FIG. 2 is a flowchart of an embodiment of a terminal control method according to the present disclosure;

FIG. 3 is a schematic view of an embodiment of a two-dimensional menu in the terminal control method according to the present disclosure;

FIG. 4 is a schematic view of an embodiment of a stitched image according to the present disclosure;

FIG. 5 is a flowchart of another embodiment of the terminal control method according to the present disclosure;

FIG. 6 is a schematic structural view of an embodiment of a terminal control device according to the present disclosure;

FIG. 7 is a schematic structural view of an embodiment of an electronic device according to the present disclosure.

### EMBODIMENTS OF THE PRESENT DISCLOSURE

Unless otherwise defined, all technical and scientific terms used herein have the same meaning as those commonly understood by technicians in the technical field of the present disclosure; the terms used in the description of the present disclosure herein are only for a purpose of describing specific embodiments and are not intended to limit the present disclosure; the terms “include” and “have” in the description, claims, and the above-mentioned drawings of the present disclosure and any variations thereof are intended to cover non-exclusive inclusions. The terms “first”, “second”, etc., in the description, claims, and the above-mentioned drawings of the present disclosure are used to distinguish different objects, not to describe a specific order.

References herein to “embodiment” means that particular features, structures, or characteristics described in conjunction with the embodiment may be included in at least one embodiment of the present disclosure. The appearance of the “embodiment” in various positions in the description does not necessarily refer to a same embodiment, nor is it an independent or alternative embodiment that is mutually exclusive with other embodiments. It is explicitly and implicitly understood by those skilled in the art that the embodiments described herein may be combined with other embodiments.

In order to enable those skilled in the art to better understand the technical solution of the present disclosure, the technical solution in the embodiments of the present disclosure will be clearly and completely described below in conjunction with the accompanying drawings.

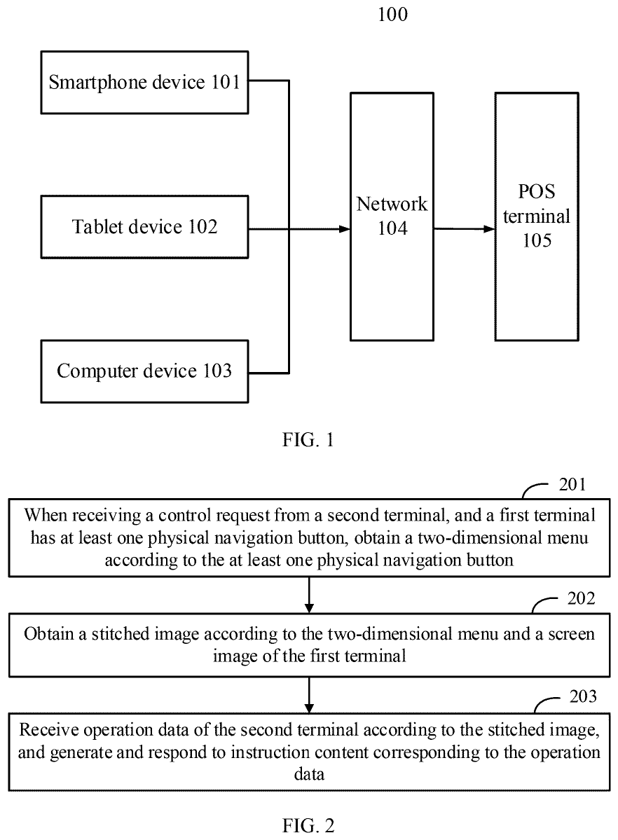

As illustrated in FIG. 1, a control architecture 100 may include a smartphone device 101, a tablet device 102, a computer device 103, a network 104, and a POS terminal 105. The network 104 is used to provide a medium for a communication link between the smartphone device 101, the tablet device 102, the computer device 103, and the POS terminal 105. The network 104 may include various connection types, such as wired, wireless communication links, or optical fiber cables, etc.

Users may use the smart phone device 101, the tablet device 102, and the computer device 1033 to interact with the POS terminal 105 through the network 104, so as to receive or send messages, etc. Various communication client applications may be installed in the smart phone device 101, the tablet device 102, and the computer device 103, such as web browser applications, shopping applications, search applications, instant messaging tools, email clients, social platform software, etc.

The smart phone device 101, the tablet device 102, and the computer device 103 may be various devices including a display screen and supporting web browsing, the smart phone device 101 includes but not limited to a smart phone, the tablet device 102 includes but not limited to a tablet computer, the computer device 103 includes but not limited to a laptop computer, and a desktop computer.

It should be noted that the terminal control method provided in the embodiment of the present disclosure is executed by a first terminal, accordingly, a terminal control device is arranged in the first terminal. The first terminal may be a device with at least one button for being remote controlled, such as the POS terminal.

It should be understood that the number of terminal devices, networks, and servers in FIG. 1 is only illustrative. Any number of terminal devices, networks, and servers may be provided according to actual requirements.

Continuing to refer to FIG. 2, FIG. 2 illustrated a flowchart of a terminal control method provided in an embodiment of the present disclosure. The terminal control method are executed by the first terminal and include the following steps:

Step 201, when receiving a control request from a second terminal, and the first terminal has at least one physical navigation button, obtain a two-dimensional menu according to the at least one physical navigation button.

In one embodiment, the first terminal may be the POS terminal, etc. The first terminal may be any device includes at least one physical navigation button. The second terminal may be any terminal device, such as a mobile terminal, etc. The POS terminal may be a device includes at least one physical navigation button, or a device includes at least one physical navigation button and at least one virtual button. The physical navigation button may be various physical buttons, which include but are not limited to a physical keyboard, a key, and a button. The virtual button may be a button displayed on the display screen of the POS terminal. If there is at least one physical navigation button on the POS terminal, a button graphic corresponding to a physical navigation button may be searched in a preset correspondence table between physical navigation buttons and button graphics. A two-dimensional menu for being stitched is generated based on one or more searched button graphics. The at least one physical navigation button may include but is not limited to a start print button, a power button, and a scan button of the POS terminal.

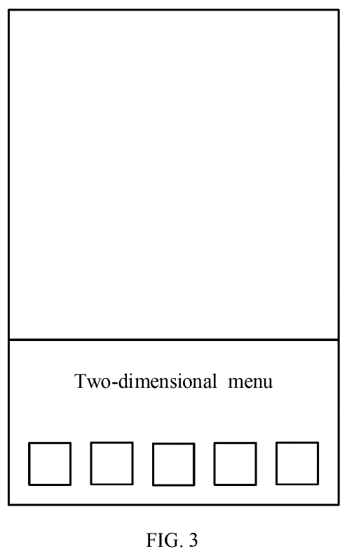

As illustrated in FIG. 3, FIG. 3 illustrated a schematic view of a stitched image obtained through the two-dimensional menu, in the stitched image, the shielded image in the POS terminal is located above the dividing line, and the area below the dividing line is the two-dimensional menu area. The box in the two-dimensional menu is generated by the button graphics corresponding to the physical navigation button.

In one embodiment, before receiving the control request from the second terminal, the mobile terminal and the POS terminal is firstly connected with a Wi-Fi hotspot to ensure that both are in a same local area network. The mobile terminal runs a client application and the POS terminal runs a server application. The mobile terminal transmits the control request to the server application of the POS terminal through the client application.

Step 202, obtain a stitched image according to the two-dimensional menu and a screen image of the first terminal.

In one embodiment, the first terminal (e.g., the POS terminal) may obtain the screen image of the first terminal in real-time, and obtain the stitched image by stitching the obtained screen image with the generated two-dimensional menu. Since different first terminals may have different numbers and types of physical navigation buttons, the first terminals with different physical navigation buttons, such as POS terminals, may generate two-dimensional menus of different styles, the two-dimensional menus are stitched with the screen image, the stitched image shown in FIG. 3 in obtained.

A size of the stitched image is usually greater than a size of the screen image of the first terminal. For example, the two-dimensional menu may be stitched above or below the screen image, in which case a height of the stitched image is greater than a height of the screen image. The two-dimensional menu may be stitched at a left or a right side of the screen image, in which case a width of the stitched image is greater than a width of the screen image.

Step 203, receive operation data of the second terminal according to the stitched image, and generate and respond to instruction content corresponding to the operation data.

In one embodiment, the first terminal detects whether the first terminal has at least one physical navigation button, when the first terminal has the at least one physical navigation button, the two-dimensional menu corresponding to the at least one physical navigation button is generated, and the two-dimensional menu is stitched with the screen image of the first terminal to obtain the stitched image. The control instructions of the users are obtained through the stitched image, and the remote control of the first terminal such as the POS terminal and other device including the at least one physical navigation button, may be realized.

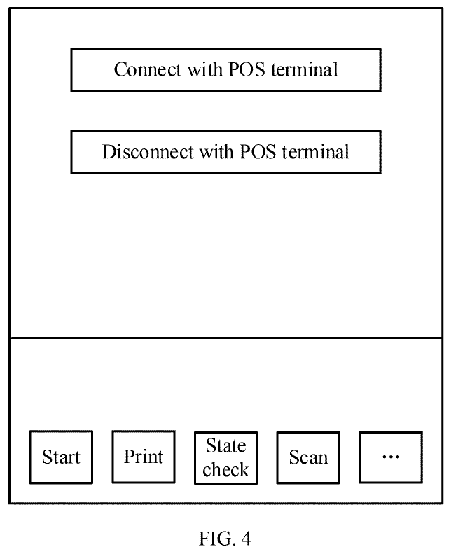

In one embodiment, as illustrated in FIG. 4, the two-dimensional menu is obtained by the button graphic corresponding to each physical navigation button being stitched in a certain order, the stitched image is obtained by stitching the two-dimensional menu with the screen image of the first terminal, and the stitched image is transmitted to the second terminal, so that the second terminal may display the stitched image. The user of the second terminal may operate in a masked area or the two-dimensional menu area of the stitched image based on the displayed stitched image, and the second terminal transmits the operation data to the first terminal, the first terminal obtains the operation data of the second terminal by parsing the received data, and executes the corresponding operation instructions. Therefore, the user may realize comprehensive control of the first terminal, such as the POS terminal, in the second terminal, such as the mobile terminal, including the control of the physical navigation buttons of the first terminal.

For example, the stitched image is displayed on the display screen of the second terminal, and the user clicks the scan button in the button image in the two-dimensional menu in the second terminal, the operation instruction may be generated according to the operation of the user in the two-dimensional menu to control the first terminal to perform a scanning action.

In one embodiment, receiving operation data of the second terminal according to the stitched image, and generating the instruction content corresponding to the operation data, includes: the first terminal transmitting the stitched image to the second terminal, the first terminal receives the operation data returned by the second terminal, the operation data includes the operation instructions and the operation positions, and the first terminal determining the instruction content of the operation instruction in the first terminal by a coordinate conversion.

In one embodiment, the POS terminal as the first terminal transmits the stitched image to the second terminal, when the POS terminal receives a first coordinate (x1, y1) of the operation position on the screen of the second terminal returned by the second terminal, the POS terminal determines whether the first coordinate (x1, y1) is in the screen image area or the two-dimensional image area in the stitched image, and determines a triggered instruction based on the operation position.

In some embodiment, the first terminal determining the instruction content of the operation instruction in the first terminal by the coordinate conversion, includes:
when the first terminal determining that the operation position is located in the area of the two-dimensional menu, determining a physical navigation button instruction in the first terminal of the operation instruction, according to a relationship between the area of the two-dimensional menu and the physical navigation button instruction;
when the first terminal determining that the operation position is located in the area of the screen image, determining the position in the screen image of the first terminal of the operation position, according to a coordinate conversion relationship between the stitched image and the image displayed by the second terminal.

In one embodiment, when determining the instruction content in the second terminal, the coordinate position of the stitched image, the coordinate position of the two-dimensional menu, and the coordinate position of the button graphic in the two-dimensional menu may be determined first. When receiving the operation instruction of the user, the operation position corresponding to the operation instruction of the user is obtained, and the operation position is compared with the coordinate position of the stitched image, the coordinate position of the two-dimensional image, and the coordinate position of the button image, the instruction content of the operation instruction is determined according to a comparison result. For example, when the operation position of the operation instruction is located in the area of the button graphic of the “scan button” in the two-dimensional menu, the instruction content of the operation instruction is determined to be a “scan” instruction.

In one embodiment, obtaining the two-dimensional menu based on the at least one physical navigation button includes: the first terminal generating the two-dimensional menu based on the at least one physical navigation button; or, the first terminal transmitting data of the at least one physical navigation button to the second terminal; and the first terminal receiving the two-dimensional menu returned by the second terminal.

In one embodiment, the two-dimensional menu is the area of the at least one physical navigation button, the two-dimensional menu may be generated in the POS terminal, or may also be generated in the mobile terminal.

The first terminal may search for a corresponding button graphic according to a detected physical navigation button, transmit the button graphic to the second terminal, and the second terminal generates the two-dimensional menu according to the button graphic for being stitched. The first terminal may also transmit the detected physical navigation button to the second terminal, the second terminal searches for the corresponding button graphic according to the physical navigation button, and the second terminal generates the two-dimensional menu based on the searched button graphic. The first terminal may also search for the corresponding button graphic according to the detected physical navigation button, and obtain the stitched image based on the searched button graphic, and transmit the stitched image to the second terminal.

That is, obtaining the stitched image according to the two-dimensional menu and the screen image of the first terminal includes: generating the stitched image by the first terminal stitching the two-dimensional menu with the screen image of the first terminal;
or, the first terminal transmitting the screen image and the two-dimensional menu of the first terminal to the second terminal, and receiving the stitched image generated by the second terminal based on the screen image and the two-dimensional menu of the first terminal;
or, when the first terminal detects that the second terminal has the two-dimensional menu, transmitting the screen image of the first terminal to the second terminal, and receiving the stitched image generated by the second terminal based on the screen image of the first terminal and the two-dimensional menu.

In one embodiment, the stitched image is an operation interface displayed in the control device. The operation interface may be generated in the POS terminal as the first terminal, and may also be generated in the mobile terminal as the second terminal. The stitched image is generated in the POS terminal and transmitted to the second terminal for display, so that the first terminal may receive the operation instruction corresponding to the physical navigation button through the second terminal. The first terminal may also transmit the two-dimensional menu and the screen image of the POS terminal as the first terminal to the mobile terminal as the second terminal, and the stitched image is generated by the mobile terminal. The mobile terminal as the second terminal may also receive the physical navigation buttons included in the first terminal to generate the two-dimensional menu, the second terminal is only required to receive the screen image of the first terminal, and generates the stitched image for display. The generation of the stitched image is completed by the above method.

In one embodiment, the terminal control method is performed by the second terminal, and the terminal control method includes:
transmitting the control request to the first terminal; receiving the stitched image from the first terminal, the stitched image including the screen image of the first terminal and the two-dimensional menu generated according to the physical navigation buttons of the first terminal; receiving the operation data based on the stitched image, and transmitting the operation data to the first terminal, the operation data being parsed by the first terminal according to the stitched image to obtain and respond to the instruction content corresponding to the operation data.

In one embodiment, after receiving the stitched image data transmitted by the POS terminal, the mobile terminal as the second terminal calls a mobile terminal system interface, utilizes a mobile terminal hard decoding function to decode the stitched image data, and renders the decoded data to a UI interface display control, so that the user may see the screen content of the POS terminal and the two-dimensional menu in real time on the UI interface display control of the application of the mobile terminal. Then, the first terminal may receive the input information of the user through the UI interface to complete the input of the user control instruction.

In one embodiment, before receiving the operation data based on the stitched image, the terminal control method further includes:
obtaining a first size of the stitched image and a second size of an area where the second terminal displays the stitched image;
resizing the stitched image according to the first size and the second size, and displaying the resized stitched image in the area where the stitched image is displayed on the second terminal.

In one embodiment, the stitched image is scaled to a certain extent, so that the stitched image may be better presented on the both screens of the first terminal and the second terminal.

In one embodiment, the control method further includes:
detecting state information of the first terminal;
rendering the state information to the stitched image, for example, the state information of the first terminal may be rendered to the two-dimensional menu, and different states may be displayed through the two-dimensional menu. By displaying the rendered state information on the second terminal, the mobile terminal as the second terminal may monitor the state of the POS terminal in real time.

The state of the POS terminal as the first terminal may include:
(1), battery level and whether the POS terminal is being charged;
(2), printer state: whether the printer is printing or out of paper;
(3), hardware and software information of the POS terminal;
(4), magnetic stripe reader state: in use or idle;
(5), IC card reader state: in use or idle;
(6), RFID card reader state: in use or idle.

When the mobile terminal as the second terminal requires some certain states of the POS terminal as the first terminal, the mobile terminal may actively transmit an instruction to the POS terminal as the first terminal to obtain the corresponding state, that is, the mobile terminal as the second terminal initiates a socket connection to the POS terminal as the first terminal, transmits the instruction when the socket connection is completed, the POS terminal receives and parses the instruction, performs corresponding operations, and calls a POS terminal system interface to obtain the corresponding state and returns the corresponding state to the mobile terminal. The mobile terminal may display the corresponding state information at a position corresponding to the stitched image.

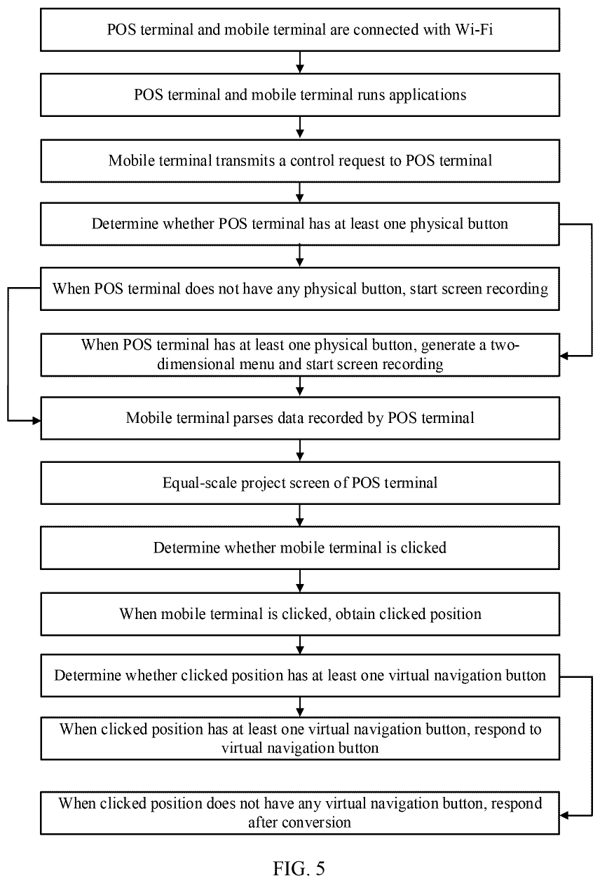

In one embodiment provided by the present disclosure, an interaction process between the mobile terminal and the POS terminal is shown in FIG. 5, which may be specifically understood as follows:

1, The mobile terminal and the POS terminal are connected with the Wi-Fi hotspot, thereby ensuring both are in the same local area network.

2, The mobile terminal runs the client application, and the POS terminal runs the server application.

3, The mobile terminal transmits screen content viewing and control instructions to the POS terminal.

4, After receiving the control instructions, the POS terminal determines whether there is at least one physical navigation button through a system interface.

5, If there is no physical navigation button, the POS terminal directly starts screen recording, and returns a width and a height of the display screen and the recorded data stream to the mobile terminal.

6, If there is at least one physical navigation button, the POS terminal draws the button graphic of the at least one physical navigation buttons according to the number of the at least one physical navigation buttons and a predetermined arrangement rule, generates the two-dimensional menu based on the drawn button graphics, and generates the stitched image by stitching the two-dimensional menu with the screen image using a certain algorithm.

7, The mobile terminal receives and parses the returned data.

8, The mobile terminal adjusts the size of the display control in proportion to a width and a height of the received stitched image, and sets the recorded data stream to the display control for display.

9, The mobile terminal starts to detect whether the display control is clicked by the user.

10, when the mobile terminal detects that the user has clicked the display control, the mobile terminal obtains coordinates of the clicked position of the display control, calculates corresponding coordinates on the display screen of the POS terminal of the clicked position based on the clicked position of the display control and an equal proportion, and transmits the corresponding coordinates on the display screen of the POS terminal to the POS terminal.

11, The POS terminal receives the coordinates transmitted by the mobile terminal and performs differentiated processing based on whether the POS terminal has at least one virtual navigation button.

12, When the POS terminal has at least one virtual navigation button, that is, the POS terminal does not have any physical navigation button, the POS terminal calls the system interface to set the returned coordinates to the system, and the system correctly responds to the click event based on the returned coordinates, regardless of whether the returned coordinates belong to the area of the at least one virtual navigation button or other areas of the display screen of the POS terminal.

13, When the POS terminal does not have any virtual navigation button, that is, the POS terminal has at least one physical navigation button, the POS terminal determines whether the coordinates belong to the two-dimensional menu or the display screen area of the POS terminal based on the returned coordinates, when the coordinates belong to the two-dimensional menu, the POS terminal calculates which physical navigation button that the coordinates belong to, and then call the corresponding system interface of the physical navigation button to respond to the click event; when the coordinates belong to the display screen area, the POS terminal calculates real coordinates of the returned coordinates on the display screen, calls the system interface to set the real coordinates to the system (the system interface is consistent with the system interface in the step 12), and the system correctly recognizes and responds to the screen click event.

Those skilled in the art may understand that all or part of the processes in the above-mentioned embodiments may be implemented by instructing the relevant hardware through computer-readable instructions, and the computer-readable instructions may be stored in a computer-readable storage medium, when the computer-readable instructions are executed, the processes of the embodiments of the above-mentioned method can be realized. The aforementioned storage medium may be a non-volatile storage medium such as a disk, an optical disk, a read-only memory (ROM), or a random access memory (RAM).

It should be understood that, although the steps in the flowchart of the accompanying drawings are displayed in sequence as indicated by the arrows, these steps are not necessarily executed in sequence as indicated by the arrows. Unless expressly stated, there is no strict sequence restriction on the execution of these steps, and these steps may be executed in other sequences. In addition, at least parts of the steps in the flowchart of the accompanying drawings may include multiple sub-steps or multiple stages, and these sub-steps or stages are not necessarily executed at the same time, but may be executed at different times, and their execution sequence is not necessarily sequential, but may be executed in sequence or alternately with other steps or at least parts of the sub-steps or stages of other steps.

Further, referring to FIG. 6, as an embodiment of the terminal control method shown in FIG. 2, the present disclosure provides an embodiment of a terminal control device, the embodiment of the terminal control device corresponds to the embodiment of the terminal control method shown in FIG. 2, and the terminal control device may be specifically applied to various electronic devices.

As illustrated in FIG. 6, the terminal control device is integrated into the first terminal, the terminal control device 600 includes: a menu generating module 601, an image generating module 602, and an instruction generating module 603.

The menu generating module 601 is configured to obtain a two-dimensional menu according to the at least one physical navigation button when receiving a control request from the second terminal and the first terminal has the at least one physical navigation button;

The image generating module 602 is configured to obtain a stitched image according to the two-dimensional menu and the screen image of the first terminal;

The instruction generating module 603 is configured to receive the operation data of the second terminal according to the stitched image, and generate and respond to the instruction content corresponding to the operation data.

In one embodiment, the instruction generating module 603 further includes:
a first processing unit, configured to transmit the stitched image to the second terminal;
a second processing unit, configured to receive the operation data returned by the second terminal, the operation data includes operation instructions and operation positions, and determine the instruction content of the operation instructions in the first terminal through the coordinate conversion.

In one embodiment, the second processing unit further includes:
a first processing subunit, configured to determine the physical navigation button instruction of the operation instruction in the first terminal according to the relationship between the area of the two-dimensional menu and the physical navigation button instructions, when the operation position is determined to be in the area of the two-dimensional menu;
a second processing subunit, configured to determine the position of the operation position in the screen image of the first terminal according to the coordinate conversion relationship between the stitched image and the image displayed on the second terminal, when the operation position is determined to be in the area of the screen image.

In one embodiment, the menu generating module 601 further includes:
a third processing unit, configured to generate the two-dimensional menu based on the at least one physical navigation button;
or, transmit data of the at least one physical navigation button to the second terminal;
receive the two-dimensional menu returned by the second terminal.

In one embodiment, the image generating module 602 further includes:
a fourth processing unit, configured to generate the stitched image by stitching the two-dimensional menu and the screen image of the first terminal;
or, transmit the screen image and the two-dimensional menu of the first terminal to the second terminal, and receive the stitched image generated by the second terminal according to the screen image and the two-dimensional menu of the first terminal;
or, when it is detected that the second terminal has the two-dimensional menu, transmit the screen image of the first terminal to the second terminal, and receive the stitched image generated by the second terminal according to the screen image and the two-dimensional menu of the first terminal.

In one embodiment, the terminal control device 600 further includes:
a request transmitting module, configured to transmit the control request to the first terminal;
an image receiving module, configured to receive the stitched image returned by the first terminal, the stitched image includes the screen image of the first terminal and the two-dimensional menu generated according to the at least one physical navigation button of the first terminal;
an instruction transmitting module, configured to receive the operation data based on the stitched image and transmit the operation data to the first terminal, the operation data is parsed by the first terminal according to the stitched image to obtain and respond to the instruction content corresponding to the operation data.

In one embodiment, the terminal control device 600 further includes:
a stitched image module, configured to obtain a first size of the stitched image and a second size of an area where the second terminal displays the stitched image;
a size conversion module, configured to resize the stitched image according to the first size and the second size, and display the resized stitched image in the area where the stitched image is displayed on the second terminal.

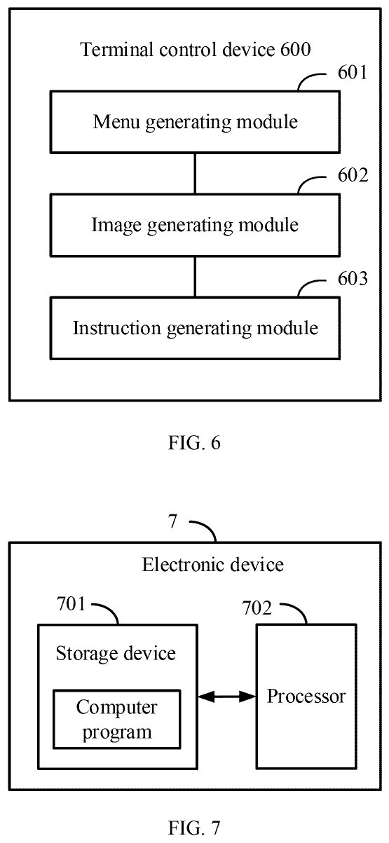

To solve the above technical problems, the present disclosure further provides an electronic device. In detail, referring to FIG. 7, FIG. 7 illustrates a basic structural block view of the electronic device of the embodiment.

The electronic device 7 includes a storage device 701 and a processor 702 which are connected with each other through a system bus. It should be noted that the figure only shows the electronic device 7 including the storage device 701 and the processor 702, but it should be understood that it is not required to implement all the components shown, and more or fewer components may be implemented instead. Those skilled in the art may understand that the electronic device is a device that may automatically perform numerical calculations and/or information processing according to preset or stored instructions, and the hardware of the electronic device includes but is not limited to microprocessors, application specific integrated circuits (ASIC), programmable gate arrays (FPGA), digital signal processors (DSP), embedded devices, etc.

The electronic device 7 may be a computing device such as a desktop computer, a notebook, a palm computer, a cloud server, etc. The electronic device may interact with the user through a keyboard, a mouse, a remote controller, a touch pad, or a voice control device.

The storage device 701 includes at least one type of readable storage medium, and the readable storage medium includes flash memory, hard disk, multimedia card, card-type memory (e.g., SD or D8 memory, etc.), random access memory (RAM), static random access memory (SRAM), read-only memory (ROM), electrically erasable programmable read-only memory (EEPROM), programmable read-only memory (PROM), magnetic memory, disk, optical disk, etc. In some embodiments, the storage device 701 may be an internal storage unit of the electronic device 7, such as a hard disk or memory of the electronic device 7. In other embodiments, the storage device 701 may also be an external storage device of the electronic device 7, such as a plug-in hard disk equipped on the electronic device, a smart media card, (SMC), a secure digital (SD) card, a flash card, etc. Of course, the storage device 701 may also include both the internal storage unit and external storage device of the electronic device 7. In one embodiment, the storage device 701 is used to store the operation system and various application software installed on the electronic device 7, such as computer-readable instructions of the terminal control method, etc. In addition, the storage device 701 may also be used to temporarily store various types of data that have been output or are to be output.

In some embodiments, the processor 702 may be a central processing unit (CPU), a controller, a microcontroller, a microprocessor, or other data processing chips. The processor 702 is used to control the overall operation of the electronic device 7. In one embodiment, the processor 702 is used to run the computer-readable instructions stored in the storage device 701 or process data, such as running the computer-readable instructions of the terminal control method.

The present disclosure further provides another embodiment, that is, provides a computer-readable storage medium, which stores the computer-readable instructions, the computer-readable instructions may be executed by at least one processor to enable the at least one processor to perform the steps of the terminal control method as described above.

Through the description of the above embodiments, those skilled in the art may clearly understand that the above-mentioned embodiment methods may be implemented by means of software plus a necessary general hardware platform, and of course by hardware, but in many cases the former is a better embodiment. Based on such understanding, the technical solution of the present disclosure, or the part that contributes to the prior art, may be embodied in a form of a software product, which is stored in a storage medium (e.g., ROM/RAM, a magnetic disk, or an optical disk), and the storage medium includes a number of instructions for a terminal device (e.g., a mobile phone, a computer, a server, an air conditioner, or a network device, etc.) to execute the method of each embodiment of the present disclosure.

Obviously, the embodiments described above are only some embodiments of the present disclosure, rather than all embodiments. The embodiments of the present disclosure are given in the accompanying drawings, but they do not limit the scope of the present disclosure. The present disclosure may be implemented in many different forms, on the contrary, a purpose of providing these embodiments is to make the understanding of the disclosure of the present disclosure more thorough and comprehensive. Although the present disclosure is described in detail with reference to the aforementioned embodiments, for those skilled in the art, it is still possible to modify the technical solutions recorded in the aforementioned specific embodiment methods, or to perform equivalent replacement of some of the technical features therein. Any equivalent structure made using the content of the description and drawings of the present disclosure, directly or indirectly used in other related technical fields, is similarly within the protection scope of the present disclosure.

1. A terminal control method implemented in a first terminal, comprising:
in response that a control request is received from a second terminal and the first terminal has at least one physical navigation button, obtaining a two-dimensional menu according to the at least one physical navigation button;
obtaining a stitched image according to the two-dimensional menu and a screen image of the first terminal; and
receiving operation data of the second terminal according to the stitched image, generating and responding to instruction content corresponding to the operation data.

2. The terminal control method according to claim 1, wherein receiving operation data of the second terminal according to the stitched image, generating and responding to instruction content corresponding to the operation data comprises:
transmitting the stitched image to the second terminal;
receiving the operation data returned by the second terminal, the operation data comprising operation instruction and an operation position, and determining the instruction content in the first terminal corresponding to the operation instruction through a coordinate conversion.

3. The terminal control method according to claim 2, wherein determining the instruction content in the first terminal corresponding to the operation instruction through the coordinate conversion comprises:
in response that the operation position is located in an area of the two-dimensional menu, determining a physical navigation button instruction of the operation instruction in the first terminal according to a relationship between the area in the two-dimensional menu and the physical navigation button instruction;
in response that the operation position is located in an area of the screen image, determining a position of the operation position in the screen image of the first terminal according to a coordinate conversion relationship between the stitched image and an image displayed by the second terminal.

4. The terminal control method according to claim 1, wherein obtaining a two-dimensional menu according to the at least one physical navigation button comprises:
generating the two-dimensional menu according to the at least one physical navigation button; or
transmitting data of the at least one physical navigation button to the second terminal; and receiving the two-dimensional menu returned by the second terminal.

5. The terminal control method according to claim 1, wherein obtaining a stitched image according to the two-dimensional menu and the screen image of the first terminal comprises:
generating the stitched image by stitching the two-dimensional menu and the screen image of the first terminal; or
transmitting the screen image of the first terminal and the two-dimensional menu to the second terminal, and receiving the stitched image generated by the second terminal according to the screen image of the first terminal and the two-dimensional menu; or
in response that the second terminal has the two-dimensional menu, transmitting the screen image of the first terminal to the second terminal, and receiving the stitched image generated by the second terminal according to the screen image of the first terminal and the two-dimensional menu.

6. A terminal control method, implemented in a second terminal, comprising:
transmitting a control request to a first terminal;
receiving a stitched image returned by the first terminal, the stitched image comprising a screen image of the first terminal and a two-dimensional menu generated according to at least one physical navigation button of the first terminal; and
receiving operation data according to the stitched image, and transmitting the operation data to the first terminal, the operation data being parsed according to the stitched image, obtained and responded to instruction content corresponding to the operation data by the first terminal.

7. The terminal control method according to claim 6, before receiving the operation data according to the stitched image, further comprising:
obtaining a first size of the stitched image, and a second size of an area where the second terminal displays the stitched image;
resizing the stitched image according to the first size and the second size, and displaying the resized stitched image in the area where the second terminal displays the stitched image.

8-10. (canceled)

11. An electronic device, comprising:
at least one processor; and
a storage device storing instructions, which when executed by the at least one processor, cause the at least one processor to:
in response that a control request is received from a second terminal and the first terminal has at least one physical navigation button, obtain a two-dimensional menu according to the at least one physical navigation button;
obtain a stitched image according to the two-dimensional menu and a screen image of the first terminal; and
receive operation data of the second terminal according to the stitched image, generate and respond to instruction content corresponding to the operation data.

12. The electronic device according to claim 11, wherein the at least one processor is further caused to:
transmit the stitched image to the second terminal;
receive the operation data returned by the second terminal, the operation data comprising operation instruction and an operation position, and determine the instruction content in the first terminal corresponding to the operation instruction through a coordinate conversion.

13. The electronic device according to claim 12, wherein the at least one processor is further caused to:
in response that the operation position is located in an area of the two-dimensional menu, determine a physical navigation button instruction of the operation instruction in the first terminal according to a relationship between the area in the two-dimensional menu and the physical navigation button instruction;
in response that the operation position is located in an area of the screen image, determine a position of the operation position in the screen image of the first terminal according to a coordinate conversion relationship between the stitched image and an image displayed by the second terminal.

14. The electronic device according to claim 11, wherein the at least one processor is further caused to:
generate the two-dimensional menu according to the at least one physical navigation button; or
transmit data of the at least one physical navigation button to the second terminal; and
receive the two-dimensional menu returned by the second terminal.

15. The electronic device according to claim 11, wherein the at least one processor is further caused to:
generate the stitched image by stitching the two-dimensional menu and the screen image of the first terminal; or
transmit the screen image of the first terminal and the two-dimensional menu to the second terminal, and receive the stitched image generated by the second terminal according to the screen image of the first terminal and the two-dimensional menu; or
in response that the second terminal has the two-dimensional menu, transmit the screen image of the first terminal to the second terminal, and receive the stitched image generated by the second terminal according to the screen image of the first terminal and the two-dimensional menu.
